(19) United States
(12) Patent Application Publication
(10) Pub. No.: US 2002/0052994 A1
(43) Pub. Date: May 2, 2002

(54) SECTION ACCESS FOR PC HARD DRIVE AND THE LIKE

(76) Inventors: LIAQAT Y. KHAN, SAN RAMON, CA (US); ALANGHAT G. KARUNAKARAN, SARATOGA, CA (US)

Correspondence Address: MCDERMOTT WILL & EMERY, 600 13TH STREET, N.W., WASHINGTON, DC, 20005-3096, US

(21) Appl. No.: 09/134,166

(22) Filed: Aug. 14, 1998

Related U.S. Application Data
(60) Provisional application No. 60/056,355, filed on Aug. 18, 1997.

(51) Int. Cl. G06F 13/00

(52) U.S. Cl. 710/300

(57) ABSTRACT

Devices for allowing peripheral devices, such as IDE and SCSI, to removably couple to a back plane of a computer system is provided using a PCI connector. One such device utilizes a printed circuit board, which maps the conventional pins of the peripheral device to 124 pins of the PCI connector. Another such device utilizes a back plane having a conventional female PCI connector that maps 124 pins to the appropriate number of lines for coupling to the motherboard. The mapping is not a one-to-one pass-through mapping. The result of the mapping increases data signal integrity and use of the PCI connector strengthens the physical connection by virtue of the 124 pins conventionally associated with PCI connections.

### RELATED APPLICATIONS

This application claims priority from provisional patent application Ser. No. 60/056,355, filed Aug. 18, 1997 and entitled “SECTION ACCESS FOR PC HARD DRIVE AND THE LIKE” which is incorporated herein by reference.

### BACKGROUND OF THE INVENTION

1. Technical Field

The present invention relates to peripheral interfaces, and more particularly to a peripheral interface that accommodates a plurality of removable hard drives.

2. Description of Related Art

Removable hard drive systems are known to accommodate a single hard drive. An example of such a hard drive is an IDE (Integrated Device Electronics) drive. IDE is a 40-line hardware interface used to connect these hard drives to computers. Standard (non-removable) IDE drives that are located within the computer housing connect a 40-line flat ribbon cable to an expansion board. The expansion board is also called a host adapter, and this plugs into an expansion slot on a motherboard which is also located within the computer housing.

Conventional connection of a removable IDE drive located outside the computer housing to the motherboard uses a connection called a pass-through. This connection is called a pass-through since a cable or printed circuit board (PCB) passes the signals using a one-to-one mapping directly from the IDE drive to the motherboard. This convention for removable IDE drives is typically limited to one drive having a housing in a 5¼ inch format. This convention does not permit the insertion of multiple drives in the same backplane, and does not take into consideration the erosion of the contacts of the pass-though over time caused by repeatedly removing the drive.

Small Computer System Interface (SCSI) hard drives are also known in the industry, and are also used as peripheral devices, in similar manner as IDE hard drives. SCSI is a hardware interface that typically uses a 50-line or 68-line which allows for the connection of up to seven or fifteen peripheral devices (hard drive, CD ROM, scanner, etc.) to a single expansion board in the computer. The expansion board is called a SCSI host adapter or SCSI controller.

Typically, removable hard drive systems employing either IDE or SCSI drives utilize a single connector that is wired directly to the drive like that shown in U.S. Pat. No. 5,563,767 to Chen. A problem with this approach is that only one hard drive can be used, and this hard drive often occupies one of typically two 5¼ inch drive bays to which the user has access. The occupation of one of the two 5¼ inch drive bays prevents other peripheral devices such as CD ROMs, tape back-up drives, and other components from being connected to a user accessible location. Furthermore, the provision of only one removable hard drive is oftentimes insufficient for the needs that are attracted to the concept of removable hard drives or other removable peripheral devices.

Therefore, one disadvantage with conventional removable hard drives is that they occupy standard slots in a personal computer to which users generally have immediate access, thus preventing other commonly used peripherals from being used simultaneously.

Another disadvantage with conventional removable hard drive systems is the lack of access to more than one removable hard drive for each removable drive system.

Yet another disadvantage with conventional systems is the inability to provide a strong, stable removable peripheral device connection that is able to withstand numerous engagements.

Another disadvantage is that the conventional one-to-one pin distributions between the hard drive and the connection to the motherboard provides an insubstantial physical link which often breaks or is damaged causing a break down in signal integrity.

### SUMMARY OF THE INVENTION

There is a need for an arrangement that accommodates for multiple removable hard drives in one housing, which do not occupy locations reserved for other peripheral devices, such as CD ROMs and tape back-up drives. There is also a need for an arrangement that employs a physically strong connector, which is keyed and fool proof for sustaining the integrity of the connector after numerous insertions of peripheral devices, such as removable hard drives.

There is also a need for an arrangement that utilizes standard components, such as a PCI connector, to take advantage of the characteristics of those components which have been proven through extended use in the industry.

These and other need are attained by the present invention, where a computer system comprises a processing unit, located on a motherboard, that performs computing functions; and a back plane that couples a peripheral device via a PCI connector to the motherboard.

Another aspect includes a peripheral tray comprising: a printed circuit board, and a peripheral device coupled to each other, wherein said printed circuit board has a tongue portion which is adapted for coupling with a PCI connector, and a base portion which interfaces with the peripheral device for transmitting power and data between the peripheral device and the printed circuit board.

A further aspect provides a back plane for a computer device, comprising a PCI connector adapted for coupling to a 40 pin IDE drive device, or a PCI connector adapted for coupling to a 50 pin SCSI drive device, or a PCI connector adapted for coupling to a 68 pin SCSI drive device.

According to one aspect of the present invention, a method of routing signals from a 40 pin IDE peripheral device to multiple 124 pin PCI connectors is provided by routing a conventional PDIAG signal of an IDE hard drive between two PCI connectors.

Another aspect of the present invention provides a method of routing signals from at least one of a 50 pin SCSI peripheral device and a 68 pin SCSI peripheral device, to a 124 pin PCI connector comprising: using 6 lines for twelve volt power, 7 lines for 5 volt power, 7 lines as reserved lines, 46 lines for ground, 4 keyed lines, 4 lines of termination power, and 27 lines of data and control; and keeping 23 lines unconnected for future use.

A still further aspect provides a method of routing signals from a 40 pin IDE peripheral device to a 124 pin PCI connector comprising: using 63 lines for data and control signals, 46 lines for ground, 4 lines for 5 volt power, 4 lines for 12 volt power, 4 keyed lines; and keeping 3 lines unconnected for future use.

Advantageously, the present invention converts a standard PCI connector to take advantage of the physically strong qualities of the PCI connector that have been proven over time and repeated use in the industry. The PCI connector interfaces with a unique printed circuit board to transmit signals between the hard drive and a backplane. The backplane receives a plurality of PCI connectors, and maps the tracings of each connector to at least one connector which is able to transmit the signals of the particular hard drive between the backplane and a computer motherboard. The PCI connector has one hundred twenty four pins to which a lesser number of pins are mapped in order to provide increased data integrity by virtue of the expanded mapping to one hundred twenty four pins. In this way, the greater number of pins, coupled with the strength of the PCI connector, provides increased physical strength of the connection as compared to one-to-one pass-through connectors. Furthermore, the majority of pins from the hard drive and motherboard are mapped to two pins on the PCI connector which advantageously improves signal integrity passed by the PCI connector even after an excessive number of insertions, which otherwise wears down the contacts of the connector.

Another advantage of the present invention is that one or a plurality of hard drives can be used in such a way that the number of drives is recognized upon booting up the computer system. Although the present invention accommodates three device bays in the standard locations, six additional peripheral devices can be connected to the backplane of the present invention, and be recognized upon computer initialization. One IDE or a pair of IDEs, one SCSI or a pair of SCSI back planes are permanently affixed within a two bay drive cage. Other combinations of IDE and/or SCSI hard drives or peripheral devices are also removable from a four bay drive cage of the computer system of the present invention, in addition to the other drives mentioned above.

Additional objects, advantages and novel features of the invention will be set forth in, or apparent from the following detailed description of the preferred embodiments of the invention.

### BRIEF DESCRIPTION OF THE DRAWINGS

Reference is made to the attached drawings, wherein elements having the same reference numeral designations represent like elements throughout and wherein:

FIG. 1 is an exploded perspective view of a computer that houses removable hard drives made in accordance with an embodiment of the present invention;

FIGS. 2A and 2B are, respectively, a partial perspective view of an embodiment of the computer shown in FIG. 1, and a transparent perspective view of a removable hard drive that is insertable into the computer of FIG. 2A;

FIGS. 3A and 3B are, respectively, perspective views of a two drive bay and a four drive bay, each housing PCI connectors that couple with the hard drive of FIG. 2B;

FIGS. 4A and 4B are schematic diagrams of a solder side and a component side, respectively, of a plug-in card used for connecting an IDE drive to a PCI connector in accordance with an embodiment of the present invention;

FIGS. 5A and 5B are schematic diagrams of a solder side and a component side, respectively, of a back plane used for mapping IDE configured lines from a motherboard to a PCI connector in accordance with an embodiment of the present invention;

FIG. 6 is a circuit schematic diagram of the plug-in card depicted in FIGS. 4A and 4B;

FIGS. 7A and 7B are circuit schematic diagrams of the two drive bay backplane depicted in FIGS. 5A and 5B;

FIGS. 8A and 8B are schematic diagrams of a solder side and a component side, respectively, of a plug-in card used for connecting a 50 pin SCSI drive to a PCI connector in accordance with an embodiment of the present invention;

FIGS. 9A and 9B are schematic diagrams of a solder side and a component side, respectively, of a plug-in card used for connecting a 68 pin SCSI drive to a PCI connector in accordance with an embodiment of the present invention;

FIGS. 10A and 10B are schematic diagrams of a solder side and a component side, respectively, of a two drive SCSI back plane used for mapping between either 50 pin or 68 pin SCSI-configured lines from a motherboard and a PCI connector in accordance with an embodiment of the present invention;

FIGS. 11A and 11B are schematic diagrams of a solder side and a component side, respectively, of a four bay SCSI back plane used for mapping between either 50 pin or 68 pin SCSI-configured lines from a motherboard and a PCI connector in accordance with an embodiment of the present invention;

FIG. 12 is a circuit schematic diagram of the plug-in card depicted in FIGS. 8A and 8B;

FIG. 13 is a circuit schematic diagram of the plug-in card depicted in FIGS. 9A and 9B;

FIG. 14 is a circuit schematic diagram of a terminator used in conjunction with the 50 pin and 68 pin SCSI drive configurations referred to in FIGS. 12 and 13;

FIGS. 15A and 15B are circuit schematic diagrams for the backplane depicted in FIGS. 10A and 10B;

FIGS. 16A-16D are circuit schematic diagrams for the backplane depicted in FIGS. 10A and 10B;

FIG. 17 is a circuit schematic diagram of the 50 pin plug-in card used in conjunction with the four bay arrangement depicted in FIGS. 15A, 15B, and 16A-16D;

FIG. 18 is a circuit schematic diagram of the 68 pin plug-in card used in conjunction with the four bay arrangement depicted in FIGS. 15A, 15B, and 16A-16D; and

FIG. 19 is a circuit schematic diagram of a terminator used in conjunction with the 50 pin and 68 pin SCSI drive configurations referred to in FIGS. 17 and 18.

### DETAILED DESCRIPTION OF THE INVENTION

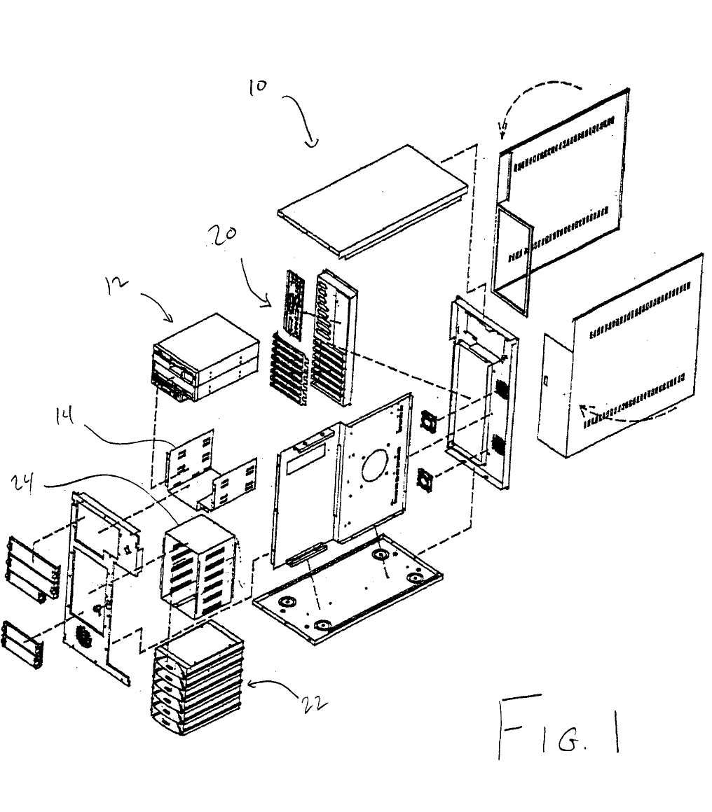

FIG. 1 is an exploded perspective view of a computer 10 (e.g., a personal computer) that houses removable hard drive trays 12 within in housing section 14., and removable hard drive trays 22 in housing section 24. Hard drive trays 12, 22 couple with a backplane 20 which is in turn coupled with a motherboard (not shown) of computer 10. The coupling of the hard drives trays 12, 22 to backplane 20 allows for data communication and power transfer between the trays and the motherboard.

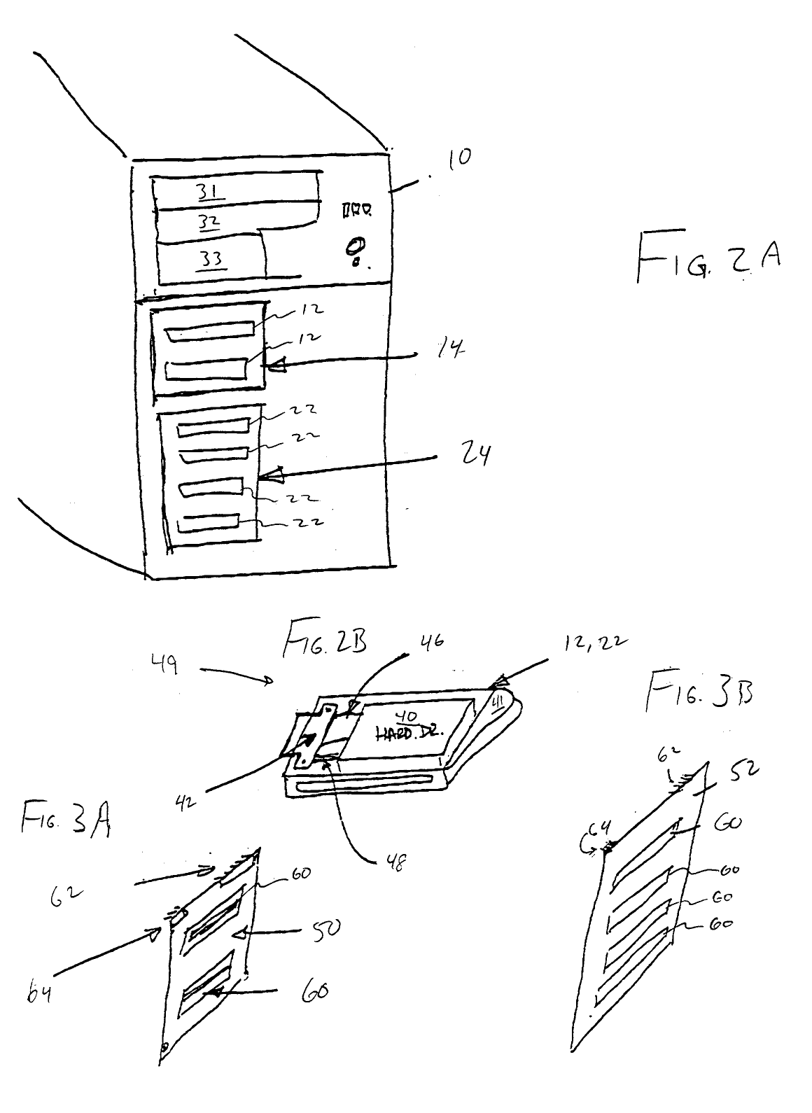

FIG. 2A is a partial perspective view of an embodiment of computer 10 shown in FIG. 1. FIG. 2A depicts the computer 10 in an assemble state, but illustrates housing section 24 as being capable of retaining four removable drive trays 22 instead of the six removable drive trays illustrated in FIG. 1. Computer 10 includes three additional drives 31, 32, 33 which are respectively a pair of 5¼ inch drives and a 3½ inch drive. Drives 31, 32, 33 are semi-permanently fixed in that they can be removed with some difficulty as compared to the easily removable drives 12 contained in section 14. Drives 31, 32 ,33 are conventional and easily accessible by a user. Drives 31, 32, 33 can also be easily adapted in a conventional manner to receive other peripheral components, for example a CD ROM, a tape drive, a floppy drive, a PCMCIA reader, a IDE drive, and a SCSI drive. The drive trays in section 24 are also easily removable, but are optional such that computer 10 need not contain section 24 at all.

FIG. 2B illustrates a transparent perspective view of a removable hard drive tray 12, 22 that is insertable into computer 10 of FIG. 2A. Hard drive tray 12, 22 includes a handle portion 41 for assisting in the insertion and removal of drive tray 12, 22 from the appropriate section 14, 24. Hard drive tray 12, 22 contains a hard drive 40 that can be any conventional hard drive, for example an IDE or SCSI hard drive. Hard drive 40 is coupled to a printed circuit board (PCB) 42 via a data cable 46 and a power cable 48. Data cable 46 is any conventional cable that carries signals from hard drive 40 to PCB 42 appropriately.

For example, in the case of an IDE drive 140 (shown generically in FIG. 2B as 40), a conventional 46 line ribbon cable would provided the data coupling. The 40-pin IDE cable is the data carrier and a separate power cable 48, which connects the PBC 42 to power pins on IDE drive 140, supplies power to drive 140. The tray 12,22, drive 40, data cable 46, power cable 48 and PCB 42 form an assembly called a drive caddy 49. Drive caddy 49 slides in and out of a metal housing, such as 14, 24 and mates with an IDE backplane (shown generically in FIG. 1 as 20). In the case of a SCSI, a conventional 50 or 68 line cable would provide the coupling depending on whether drive 40 was a “narrow” SCSI or “wide” SCSI drive.

FIGS. 3A and 3B are, respectively, perspective views of a two drive bay back plane 50 and a four drive bay back plane 52. Each back plane 50, 52 comprises a plurality of PCI connectors 60 that receive PCB 42 of hard drive trays 12, 22. Each back plane 50, 52 also includes a data cable connector 62 and a power cable connector 64 that couple the back plane to a motherboard (not shown) contained within the housing of computer 10. As is typical with computers, the motherboard contains a processor, which performs computing functions in a conventional manner and will not be discussed further so as not to distract from the present inventions.

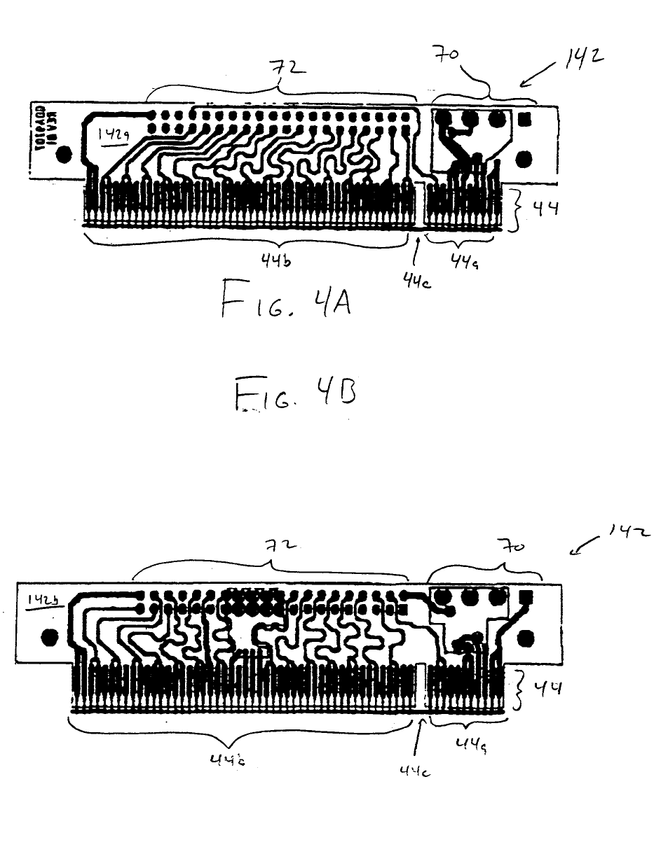

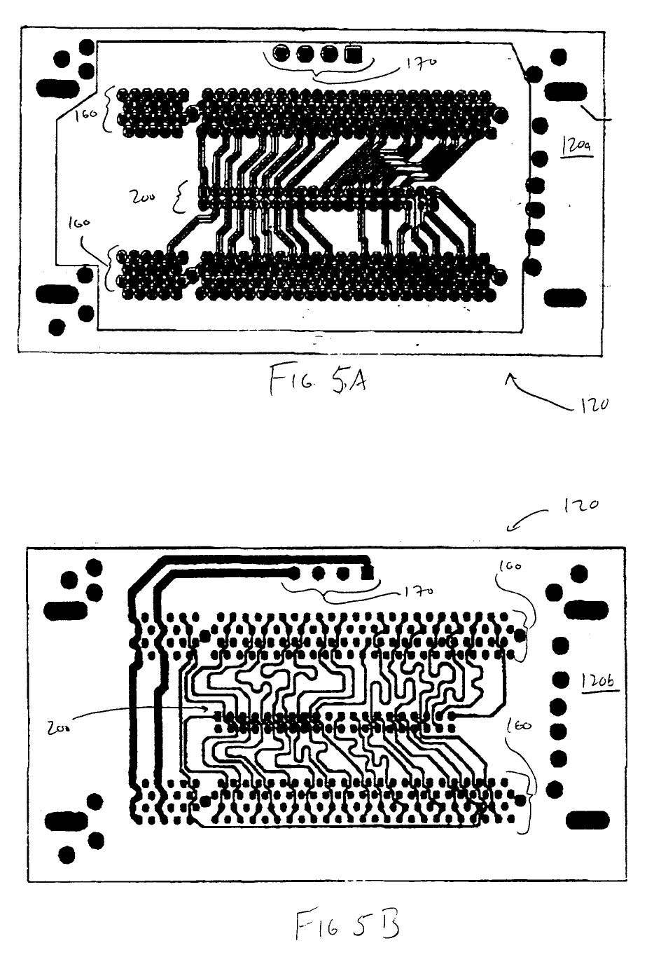

FIGS. 4A and 4B are schematic diagrams of a solder side 142a and a component side 142b, respectively, of PCB 42 which is generally used for connecting a hard drive 40 to a PCI connector in accordance with an embodiment of the present invention. PCB 42 is referred to as plug-in card 142 in FIGS. 4A and 4B when the hard drive 40 is an IDE drive 140 (shown generically as drive 40).

Plug-in card 142 includes a card edge 44 which is flat like a card and plugs into PCI connectors 60. Card edge 44 is configured to couple with 124 pins of PCI connector 60. Card edge conforms to the physical specifications of the slot on PCI connector 60. The PCI connector is the female-type portion which mates with the card edge 44 which is the male-type portion; together the PCI connector and card edge form a strong, but removable joint.

FIG. 4A illustrates card edge 44 as having 11 pins 44a which are separated from 59 pins 44b by a key 44c that has 2 pins, for a total of 62 pins. FIG. 4B shows a similar configuration for component side 142b, for a total of 124 pins that couple with PCI connectors 60.

FIGS. 4A and 4B also depict four power contacts 70, and forty data contacts 72. The forty data contacts are associated with the conventional format of IDE drives, but it is the mapping between the power contacts 70 and data contacts 72 of each layer 142a. 142b onto the 124 PCI connector pins that provides a novel aspect of the present invention.

The 124 PCI pins do not mate one-to-one to the IDE specification of 40 pins. The mating between plug-in card 142 and IDE hard drive 140, therefore, could not be a one-to-one connection as was done in other approaches. The 40 pins are distributed over 124 pins, i.e., the data traffic are directed in a special way to keep the data integrity intact, as well as provide enough grounding pins to prevent any static problems.

Although the card edge provides a removable mating, this repeated removing may also cause erosion of the contact over time. To safeguard against contact erosion, each one of the 40 pins from the hard drive cable connects to two pins on the PCI edge. Since the card edge 44 experiences erosion during the in and out action, dual pin connection provides a back up that will continue to hold the data integrity and prevent failures.

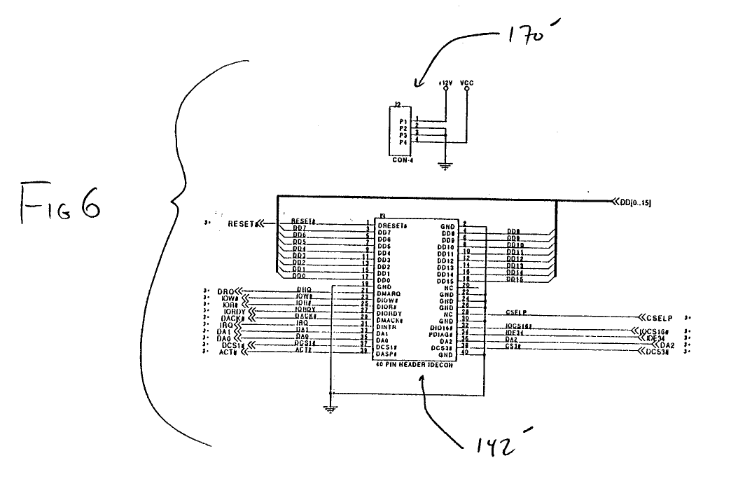

FIGS. 5A and 5B are schematic diagrams of a solder side 120a and a component side 120b, respectively, which together define a two bay IDE back plane (120). Backplane 120 is used for mapping forty IDE pins 200, that are configured in IDE format for communication between the motherboard, to PCI connectors 160 in accordance with an embodiment of the present invention. The two bay IDE backplane 120 is the middleman between the embedded IDE controller on the motherboard and the drive caddy (as defined earlier). Backplane 120 is mounted at the back of the metal housing in the system chassis. Backplane 120 provides the vehicle to connect multiple hard drive caddies (two in this case), easily and without the aid of tools and/or training.

Backplane 120 has two PCI connectors 160, which flank a 40-pin IDE connector. On one edge of the backplane 120 is the power cable connector 170. The PCI connectors 160 are female-type connectors with a long slot that accepts the male card edge 44 on plug-in card 142.

A 40-pin connector 200 on backplane 120 connects backplane 120 to the IDE controller on the motherboard via a flat ribbon cable. The power connector 170 on backplane 120 is connected to the power cable from the power supply of the computer system. The power is supplied to the backplane for the hard drive. The power signals are carried via the traces on backplane 120 through PCI connectors 160, to plug-in card 142, through the power cable 46 into the hard drive 142. This set up allows the mating and de-mating of the caddy possible in a clean fashion.

The two PCI connectors 160 on backplane 120 allow two hard drives 140 to be running simultaneously. The circuitry is laid out in such a way as to recognize either one or both of the drives, individually or one at a time, regardless of which PCI slot of the two bay section 14 is used first. The user of the system can therefore use the second hard drive as a backup or take both drives out for security reasons. There is no industry standard device available to achieve the aspects mentioned above.

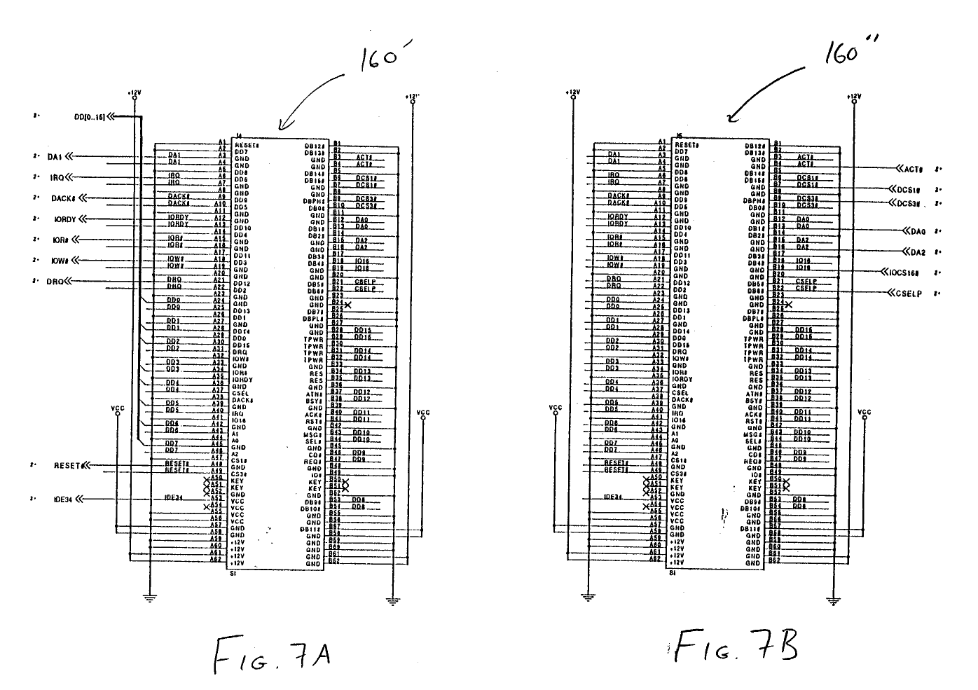

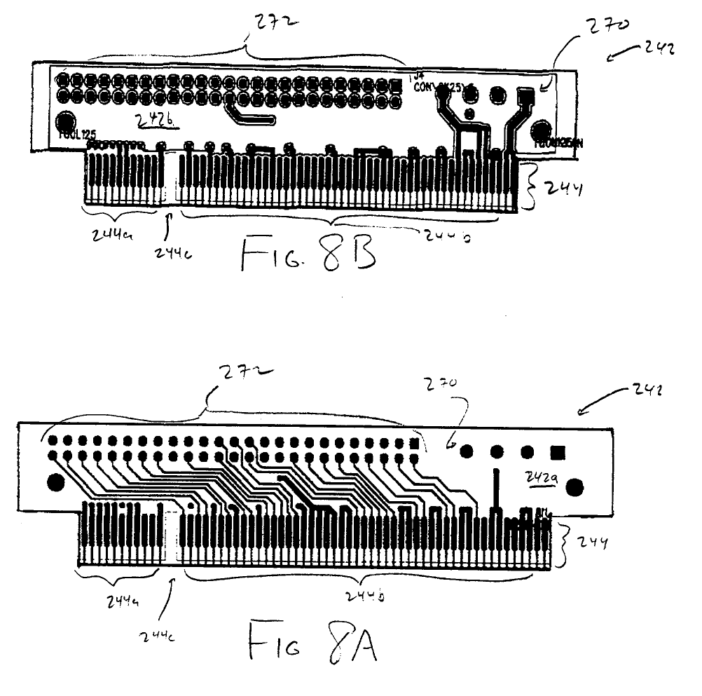

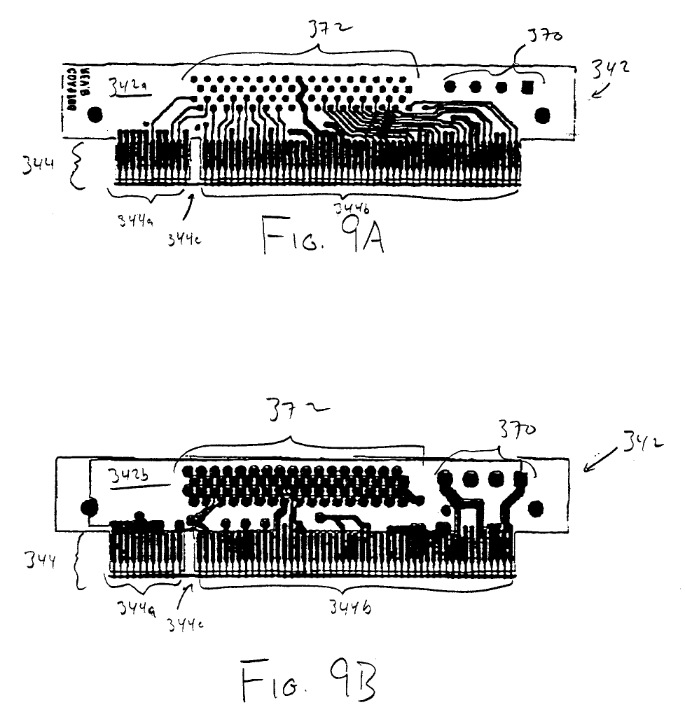

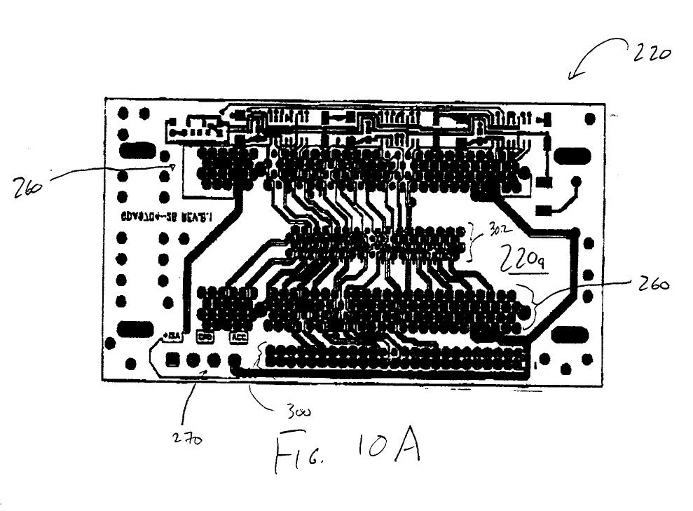

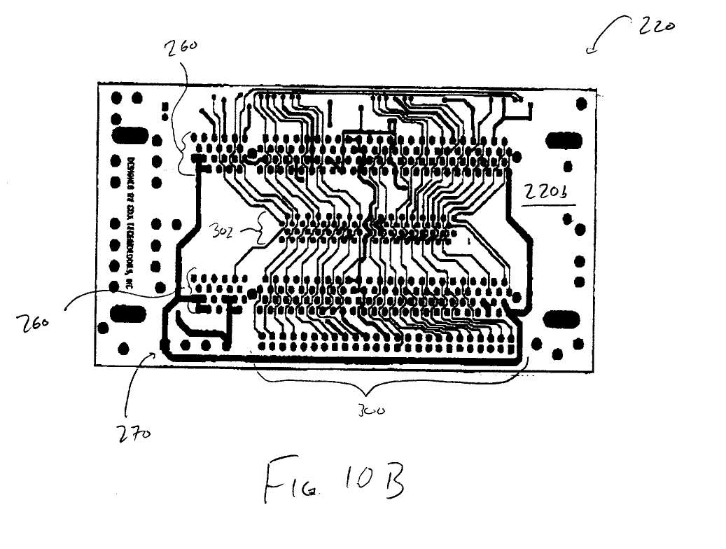

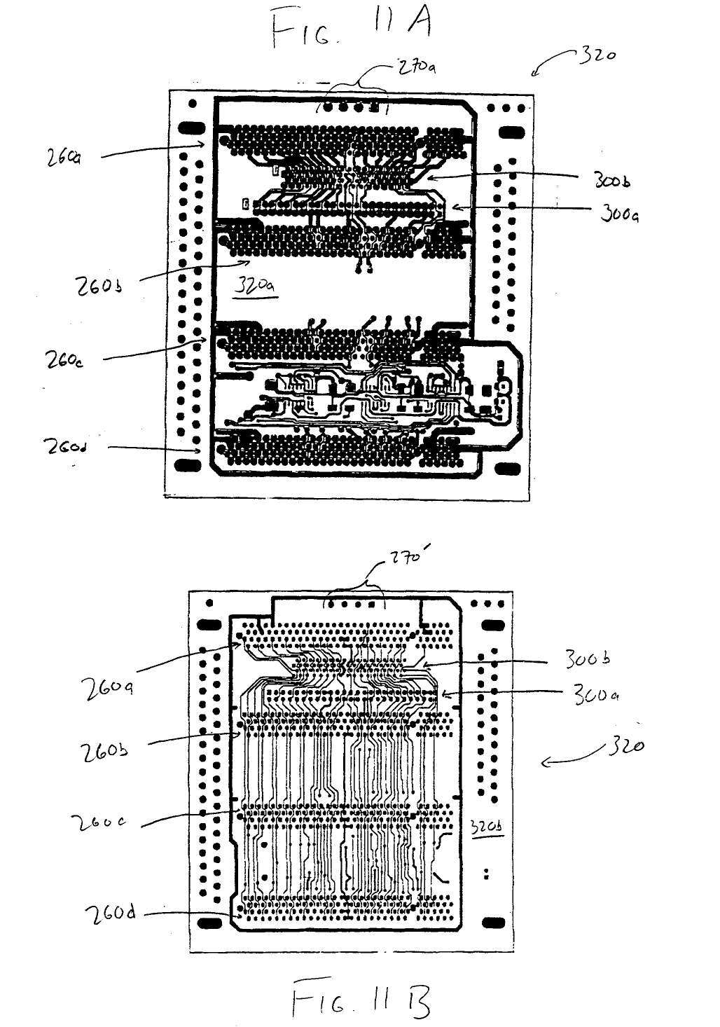

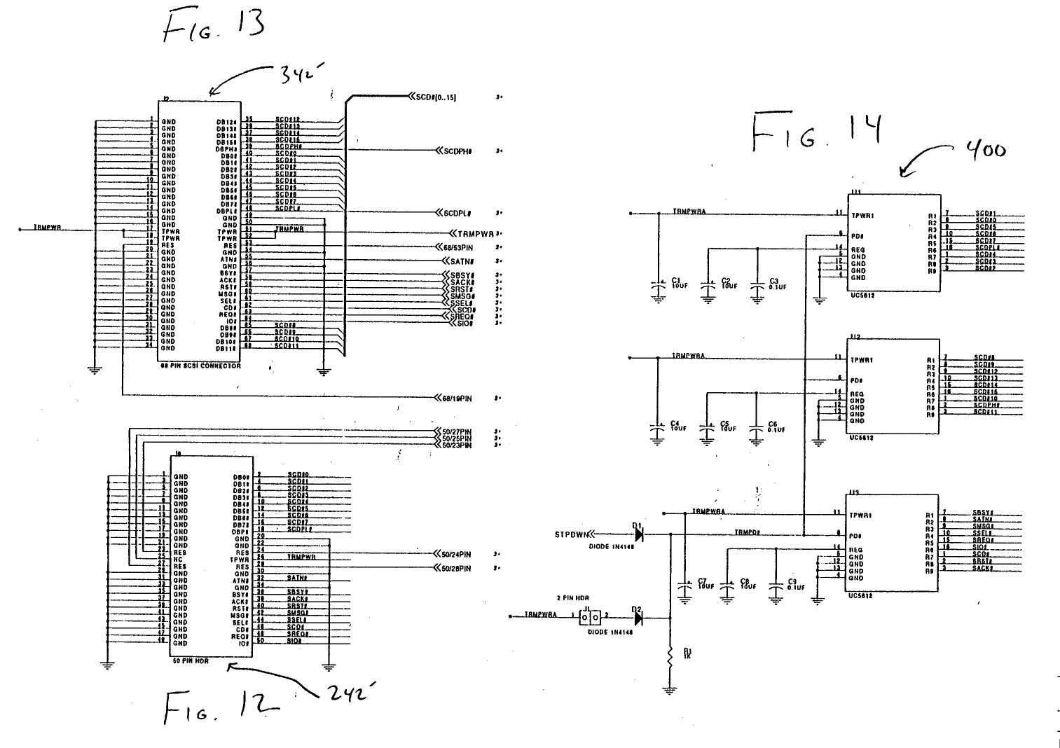

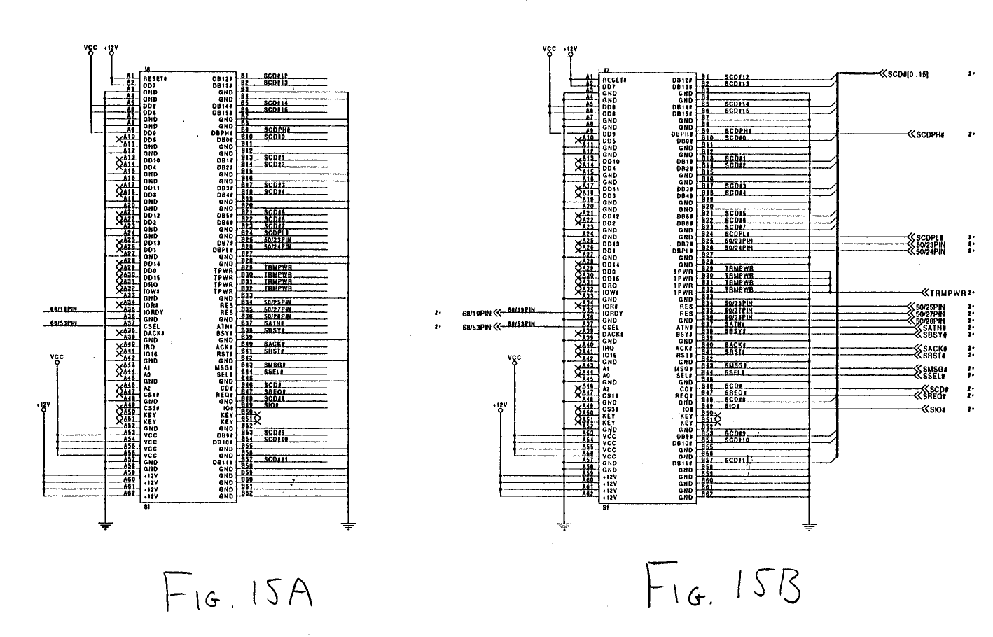

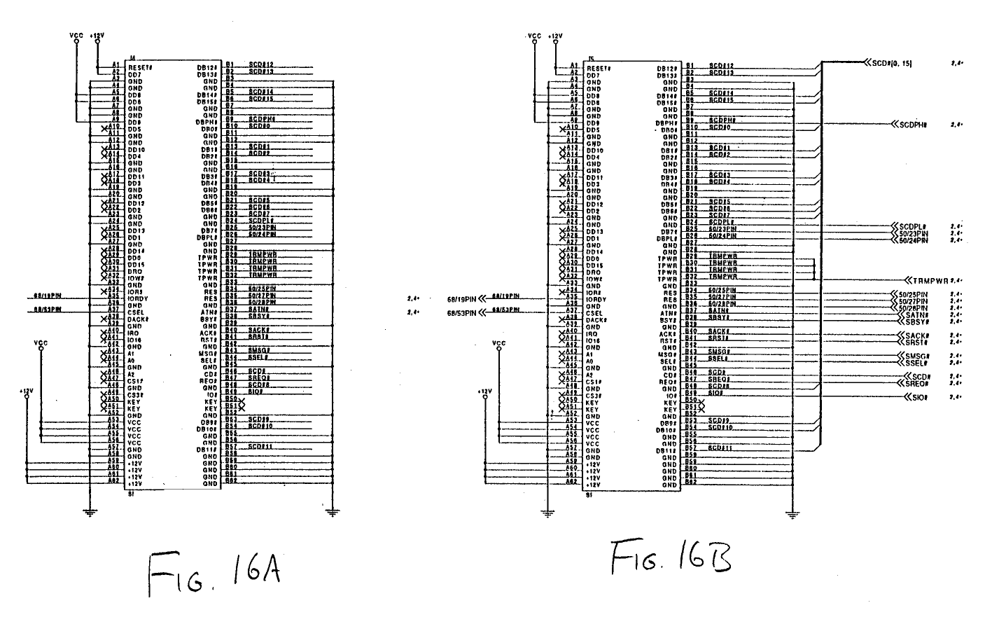

FIG. 6 is a circuit schematic diagram of plug-in card 142 depicted in FIGS. 4A and 4B. IDE Plug-in card 142′ is the bridge between IDE hard drive 140 and an IDE backplane (discussed in greater detail below). FIG. 6 includes a circuit schematic for the power contacts 170′ that is separated from the circuit schematic for data contacts 142′.

FIGS. 7A and 7B are circuit schematic diagrams of the two drive bay backplane depicted in FIGS. 5A and 5B. FIGS. 7A and 7B illustrate each of the two PCI connectors described in conjunction with FIGS. 5A and 5B. In FIG. 7A, numeral 160′ designates the PCI connector of FIGS. 5A and 5B closest to power contacts 170 while numeral 160″ designates the PCI connector furthest from power contacts 10.

In determining the mapping of the 40 IDE pins of contacts 200 to the 124 PCI pins of contacts 160 as shown in FIGS. 7A and 7B, one IDE signal was traced to two PCI contacts, with ground interleaved in between. Each signal has equal trace length to improve signal integrity and timing. Furthermore, the conventional PDIAG signal is intentionally not driven by the controller on the motherboard. In order to make two drives work on the backplane, PDIAG signal had to be routed between the two PCI connectors. This is a particularly unique feature of this design.

The mapping of FIGS. 6, 7A and 7B is best described using the table corresponding to pins A1-A62 and the table corresponding to pins B1-B62, each shown below:

A1 through A62

| | |
|---|---|
| DD0-DD7 (8 signal line) | 16 lines |
| IOR#, IOW#, IORDY, DACK#, | 17 lines |
| DRQ, IRQ, DA1, RESET#, Reserved | |
| Ground | 21 lines |
| VCC (5 v) | 2 lines |
| +12 V | 2 lines |
| Key | 2 lines |
| No connects | 2 lines |
| Total | 62 lines |

B1 through B62

| | | |
|---|---|---|
| DD8-DD15 (8 SIGNAL LINES) | 16 | lines |
| CSELP, IO16, DA2, DA0, DCS3#, DCS1#, ACT# | 14 | Lines |
| Ground | 25 | lines |
| VCC (5 V) | 2 | lines |
| 12 V | 2 | lines |
| Key | 2 | lines |
| No connect | 1 | line |
| Total | 62 | lines |

FIGS. 8A and 8B are schematic diagrams of a solder side 242a and a component side 242b that together form a plug-in card 242 used for connecting a 50 pin SCSI drive 240 to a PCI connector 260 in accordance with an embodiment of the present invention. Plug-in card 242 is similar in many respects to that discussed in conjunction with plug-in card 142. However, since card 242 is adapted for a 50 pin SCSI drive, as opposed to the 40 pin IDE drive, the like elements are represented by numerals in the 200 series instead of 100 series (e.g., 242 for the 50 SCSI pin plug-in card instead of 142 for 40 pin IDE plug-in card). One distinction worth mentioning specifically is the 50 pins labeled with numeral 272 in both FIGS. 8A and 8B.

FIGS. 9A and 9B are schematic diagrams of a solder side and a component side, respectively, of a plug-in card used for connecting a 68 pin SCSI drive to a PCI connector in accordance with an embodiment of the present invention. Therefore, the like numerals are represented by the 300 series instead of the 100 series (e.g., 342 instead of 142 or 242). One distinction worth mentioning specifically is the 68 pins labeled with numeral 372 in both FIGS. 9A and 9B. The mapping of 50 pins to 124 pins, and of 68 pins to 124 pins of FIGS. 8A/8B and 9A/9B is discussed in greater detail below.

FIGS. 10A and 10B are schematic diagrams of a solder side 220a and a component side 220b, respectively, of a two drive SCSI back plane 220 used for mapping between a 50 pin SCSI contact 300 and a 68 pin SCSI contact 302. Each SCSI contact 300, 302 couples with the motherboard and 124 pin PCI connectors 260 in accordance with an embodiment of the present invention specifically show in the figures, thus allowing four hard drives to be running simultaneously.

FIGS. 11 A and 11B are schematic diagrams of a solder side 320a and a component side 320b, respectively, of a four bay SCSI back plane 320 used for mapping between a 50 pin SCSI contact 300a and a 68 pin SCSI contact 302a. There are four PCI connectors 260a, 260b, 260c, 260d on backplane 320, thus allowing four hard drives to be running simultaneously. The circuitry is laid out in such a way as to recognize either one or all the drives, individually or one at a time, regardless of which PCI slot is used first. The user of the system can therefore use the second, third and fourth hard drive as a backup or take all the drives out for security reasons.

Each SCSI contact 300a, 302a couples with the motherboard and 124 PCI connectors 260a, 260b, 260c, 260d in accordance with an embodiment of the present invention.

The SCSI back planes depicted in FIGS. 10A, 10B, 11A, 11B are each similar to the IDE back plane disclosed in conjunction with FIGS. 5A, 5B. One significant difference is the unique mapping each back plane exhibits which is discussed in greater detail below with the circuit schematics.

FIG. 12 is a circuit schematic diagram 242′ of the 50 pin SCSI plug-in card 242 depicted in FIGS. 8A and 8B. FIG. 13 is a circuit schematic diagram 342′ of the 68 pin SCSI plug-in card 342 depicted in FIGS. 9A and 9B. Both SCSI plug-in cards 242, 342 have power contacts configured as disclosed with respect to that of element 170′ of FIG. 6. FIG. 14 is a circuit schematic diagram of a terminator 400 that is used in conjunction with the 50 pin and 68 pin SCSI drive configurations referred to in FIGS. 10 and 11. One terminator 400 is used in the SCSI back plane 220, 320 and one on the motherboard to terminate the SCSI daisy chain without any need to attach a terminator at a particular drive. This is advantageous since it allows a user to insert the removable hard drives in any SCSI location without having to worry about setting up the correct terminator configuration relative to any other drives inserted into computer 10.

FIGS. 15-19 are similar in many respects to that described in conjunction with the IDE drive discussion above. Additionally, the two bay SCSI back plane and the four bay SCSI back plane configurations are also very similar.

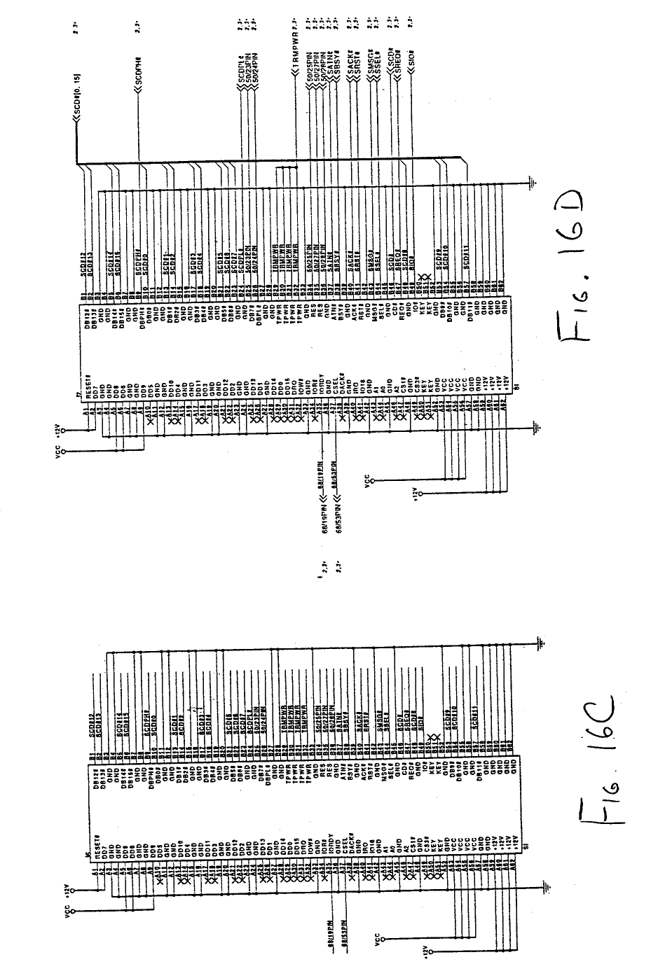

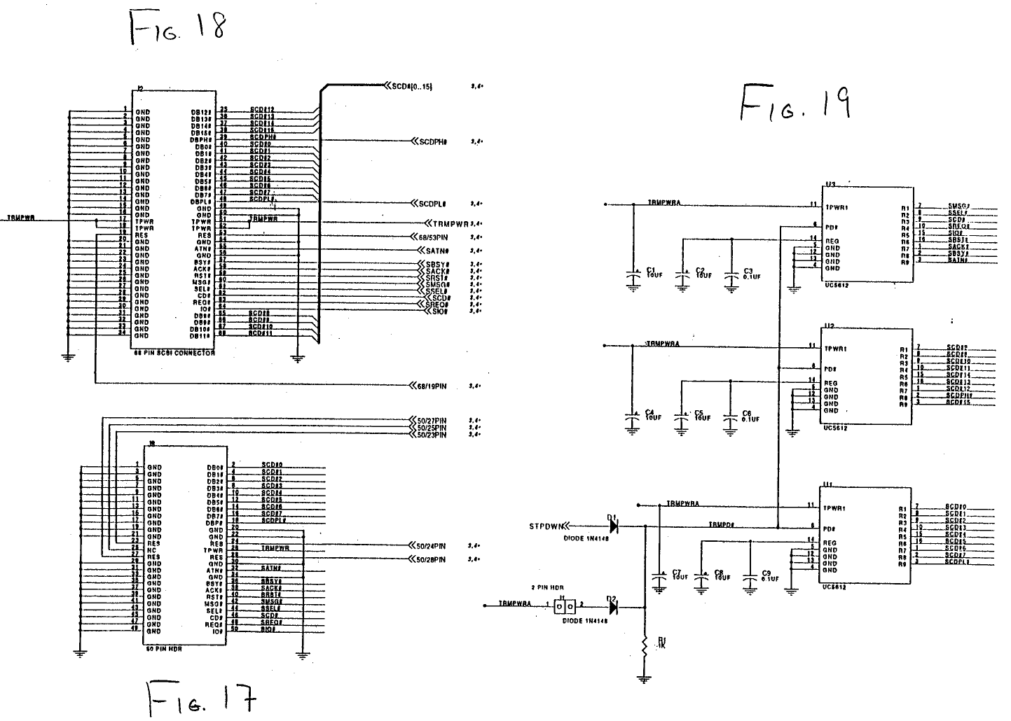

FIGS. 15A and 15B are circuit schematic diagrams for the two bay SCSI backplane depicted in FIGS. 10A and 10B. FIGS. 16A-16D are circuit schematic diagrams for the four bay SCSI backplane depicted in FIGS. 11A and 11B. FIG. 17 is a circuit schematic diagram of the 50 pin plug-in card used in conjunction with the four bay arrangement depicted in FIGS. 15A, 15B, and 16A-16D. FIG. 18 is a circuit schematic diagram of the 68 pin plug-in card used in conjunction with the four bay arrangement depicted in FIGS. 15A, 15B, and 16A-16D. FIG. 19 is a circuit schematic diagram of a terminator used in conjunction with the 50 pin and 68 pin SCSI drive configurations referred to in FIGS. 17 and 18.

The 50 SCSI pin is a subset of 68 SCSI pin, and therefore these arrangements are discussed together. The subset-nature of the 50 and 68 pin SCSI versions allows the connection between the motherboard and the backplane via either a 50 pin cable (“narrow”) or 68 pin cable (“wide”). When using a 50 pin cable, all the drives have to be “narrow” SCSI format, but when a 68 pin cable is used, the drives can implement the “narrow” or “wide” combination.

To emphasize some of the pertinent characteristics of mapping 50 and 68 pin SCSI to the 124 pin PCI connector, attention should be paid to the signal mapping disclosed in table form below.

### Pin Definitions and Mapping

### SCSI 50 and SCSI 68

The following signals are made common between 50 and 68 pin routing on the backplane.

SCD 0 through 7 (8 signal lines)

SCDPL#

SATN#

SBSY#

SACS#

SRST#

SMSG#

SSEL#

SCD#

SREQ#

SIO#

SCD 8 Through 15 and SCDPH# (9 signal lines are defined as upper byte of the 16 bit SCSI, including parity.

### SCSI 50 Pin or SCSI 68 Pin to PCI 124 Pin Mapping

PCI connector has two sides with 62 pins on each side. A1 through A62 accounts for one side and B1 through B62 is the other side.

A1 through A62

| | |
|---|---|
| 12 Volt Power | 6 lines |
| 5 Volt Power | 7 lines |
| Reserved | 2 lines |
| Ground | 22 lines |
| Key | 2 lines |
| No connect | 23 lines |
| Total | 62 lines |

B1 through B62

| | |
|---|---|
| Data and Control | 27 lines |
| Termination Power | 4 lines |
| Reserved | 5 lines |
| Ground | 24 lines |
| Key | 2 lines |
| Total | 62 lines |

The following advantages are realized due to the unique mapping scheme mentioned immediately above:

1. Improved routability of signals.

2. Better signal integrity due to the large number and distribution of ground signals and a dedicated power plane as ground on one whole side of the backplane.

3. Large number of power and ground pin (12 Volt and 5 Volt) are defined for the connector and the bus to avoid voltage drops across contacts.

4. Ventilation holes are provided on the backplane for air circulation and cooling.

It should be noted that with the multiple IDE and SCSI peripheral devices described above, various combinations can be implemented. The following table provides a summary of these possible combinations:

TABLE
Combinations of Hard Drives

| | Two Bay Section 14 | Four Bay Section 24 |
|---|---|---|
| Combination Number | drives 1, 2 | drives 1, 2; 3, 4 |
| 1 | IDE, IDE | - ; - |
| 2 | IDE, IDE | IDE, IDE; - |
| 3 | IDE, IDE | - ; IDE, IDE |
| 4 | IDE, IDE | IDE, IDE; SCSI, SCSI |
| 5 | IDE, IDE | SCSI, SCSI; SCSI, SCSI |
| 6 | IDE, IDE | SCSI, SCSI; - |
| 7 | IDE, IDE | - ; SCSI, SCSI |
| 8 | SCSI, SCSI | - ; - |
| 9 | SCSI, SCSI | IDE, IDE; - |
| 10 | SCSI, SCSI | - ; IDE, IDE |
| 11 | SCSI, SCSI | IDE, IDE; IDE, IDE |
| 12 | SCSI, SCSI | IDE, IDE; SCSI, SCSI |
| 13 | SCSI, SCSI | SCSI, SCSI; SCSI, SCSI |
| 14 | SCSI, SCSI | SCSI, SCSI; - |
| 15 | SCSI, SCSI | - ; SCSI, SCSI |

While this invention has been described in connection with what is presently considered to be most practical and preferred embodiments, it is to be understood that the invention is not limited to the disclosed embodiments, but, on the contrary, is intended to cover various modifications and equivalent arrangements included within the spirit and scope of the appended claims.

What is claimed is:

1. A computer system comprising:
a processing unit, located on a motherboard, that performs computing functions; and
a back plane that couples a peripheral device via a PCI connector to the motherboard.

2. The computer system of claim 1, wherein the back plane that couples the peripheral device comprises an IDE device that is removably coupled to the PCI connector.

3. The computer system of claim 2, wherein the back plane couples a pair of peripheral devices, each comprising an IDE device that is removably coupled to the PCI connector.

4. The computer system of claim 3, wherein the PCI connector includes one hundred twenty four lines that are mapped to forty lines which are coupled to the motherboard.

5. The computer system of claim 1, wherein the back plane couples the peripheral device comprising a SCSI device that is removably coupled to the PCI connector.

6. The computer system of claim 4, wherein the back plane couples a pair of peripheral devices, each comprising a SCSI device that is removably coupled to the PCI connector.

7. The computer system of claim 6, wherein the PCI connector includes one hundred twenty four lines that are mapped to fifty lines which are coupled to the motherboard.

8. The computer system of claim 6, wherein PCI connector includes one hundred twenty four lines that are mapped to sixty-eight lines which are coupled to the motherboard.

9. The computer system of claim 1 further comprising a second back plane that couples a second peripheral device via a second PCI connector to the motherboard.

10. The computer system of claim 9, wherein the second back plane receives two pairs of peripheral devices.

11. The computer system of claim 10, wherein each of the two pairs of peripheral devices comprise either a pair of IDE devices or a pair of SCSI devices.

12. The computer system of claim 11, wherein the first back plane comprises a pair of IDE peripheral devices and the second back plane comprises at most one pair of IDE peripheral devices.

13. The computer system of claim 1, further comprising a device tray comprising a printed circuit board that maps forty lines of an IDE peripheral device to one hundred twenty four pins for coupling to the PCI connector, the device tray being received by the PCI connector.

14. The computer system of claim 1, further comprising a device tray comprising a printed circuit board that maps fifty lines of a SCSI peripheral device to one hundred twenty four pins for coupling to the PCI connector, the device tray being received by the PCI connector.

15. The computer system of claim 1, further comprising a device tray comprising a printed circuit board that maps sixty eight lines of a SCSI peripheral device to one hundred twenty four pins for coupling to the PCI connector, the device tray being received by the PCI connector.

16. The computer system of claim 4, further comprising a device tray comprising a printed circuit board that maps forty lines of an IDE peripheral device to one hundred twenty four pins coupled to the PCI connector, the device tray being received by the PCI connector.

17. The computer system of claim 7, further comprising a device tray comprising a printed circuit board that maps fifty lines of a SCSI peripheral device to one hundred twenty four pins coupled to the PCI connector, said device tray being received by the PCI connector.

18. The computer system of claim 8, further comprising a device tray comprising a printed circuit board that maps sixty eight lines of a SCSI peripheral device to one hundred twenty four pins coupled to the PCI connector, said device tray receiving the PCI connector.

19. A peripheral tray comprising:
a printed circuit board, and a peripheral device coupled to each other,
wherein said printed circuit board has a tongue portion which is adapted for coupling with a PCI connector, and a base portion which interfaces with the peripheral device for transmitting power and data between the peripheral device and the printed circuit board.

20. The invention of claim 19 wherein the peripheral device is selected from the group consisting of a CD ROM, a tape drive, a floppy drive, a PCMCIA reader, a IDE drive, and a SCSI drive.

21. A back plane for a computer device, comprising a PCI connector adapted for coupling to a 40 pin IDE drive device.

22. A back plane for a computer device, comprising a PCI connector adapted for coupling to a 50 pin SCSI drive device.

23. A back plane for a computer device, comprising a PCI connector adapted for coupling to a 68 pin SCSI drive device.

24. A method of routing signals from a 40 pin IDE peripheral device to multiple 24 pin PCI connectors by routing a conventional PDIAG signal of an IDE hard drive between two PCI connectors.

25. A method of routing signals from at least one of a 50 pin SCSI peripheral device and a 68 pin SCSI peripheral device, to a 124 pin PCI connector comprising:
using 6 lines for twelve volt power, 7 lines for 5 volt power, 7 lines as reserved lines, 46 lines for ground, 4 keyed lines, 4 lines of termination power, and 27 lines of data and control; and
keeping 23 lines unconnected for future use.

26. A method of routing signals from a 40 pin IDE peripheral device to a 124 pin PCI connector comprising:
using 63 lines for data and control signals, 46 lines for ground, 4 lines for 5 volt power, 4 lines for 12 volt power, 4 keyed lines; and
keeping 3 lines unconnected for future use.

27. The computer system of claim 1, wherein the back plane couples at least two removable peripheral device bays.
